(19) United States
(12) Patent Application Publication
(10) Pub. No.: US 2012/0083566 A1
(43) Pub. Date: Apr. 5, 2012

(54) INK COMPOSITIONS

(76) Inventors: Jason Lazarus Deiner, San Diego, CA (US); Sergiy Peleshanko, San Diego, CA (US); Lane A. Gregg, San Diego, CA (US)

(21) Appl. No.: 13/320,907

(22) PCT Filed: Jun. 18, 2009
(86) PCT No.: PCT/US09/47861

§ 371 Date: Nov. 16, 2011

(51) Int. Cl. C09D 11/10

(52) U.S. Cl. 524/507

(57) ABSTRACT

Ink composition comprising an liquid vehicle, a colorant system, fluoropolymer particles and polyurethane binders wherein the polyurethane binders has a percentage of hard segment which is below 49 percent.

### BACKGROUND OF THE INVENTION

Inkjet printing is a popular technique for recording images on various media surfaces, particularly on papers. Inkjet printing technique is accomplished by projecting a stream of ink droplets to a surface to form the desired printed image. Such technique does not require any contact between the printing device and the substrate on which the printed characters are deposited. Inkjet printers have found broad applications across different markets ranging from desktop document and photographic-quality imaging, to short run printing and industrial labeling. This technique is, nowadays, very popular among customers. Though there has been great improvement in inkjet printing, improvements are followed by increased demands from consumers, for higher speeds, higher resolution, full color image formation or increased stability. Thus, there has been a constant need for ink compositions to meet certain features to be useful in inkjet printing operations. Such good characteristics are viscosity, resistivity, solubility, compatibility of components and wettability of the substrate. Furthermore, it is often desirable to obtain inks which are quick drying and smear resistant, capable of passing through the ink jet nozzle without clogging and that permit rapid cleanup of the machine components with minimum effort. Another challenge for printing composition is the stability and durability of the image created on the various types inkjet receivers.

It is generally known that inks, especially inks with pigments as colorants, provide good image stability, good light fade resistance and good water resistance. However, one of the greatest potential weaknesses of photo-prints made with inks is that they are susceptible to scratching, scuffing, nicking and burnishing. Indeed, these images are prone to the types of mechanical wear that may occur from everyday handling. This scratching tendency is very problematic to consumers who tends to handle and to ship printed images. Therefore, it is desirable to obtain ink-printing compositions which can create high durability photo prints and which have good physical durability.

Thus, it is desirable to have ink compositions that provide good printing quality (such as good image quality, gloss, water fastness, wet adhesion) in the same time with good image durability. Especially, it is desirable to have ink jet compositions that present excellent scratch resistance and address all problems of scratching in the same time, i.e. scuff, abrasion and burnishing while maintaining good jettability.

### BRIEF DESCRIPTION OF THE DRAWINGS

In order to better understand the invention, some embodiments will be described below by way of non-limiting examples only, with reverence to figures, wherein:

FIG. 1 is a graph plotting Optical Density loss (%) vs. Print Density of different inks according to one embodiment of the present invention.

FIG. 2 is a series of bar graphs that compare the average gloss of different inks according to one embodiment of the present invention.

FIG. 3 is a graph plotting Optical Density loss (%) vs. Print Density for inks having different level of fluoropolymer particles according to one embodiment of the present invention.

FIG. 4 is a series of bar graphs that compare ink decap time of different inks according to one embodiment of the present invention.

FIG. 5 is series of print, recorded with different inks, resulting from the Fiorino test according to one embodiment of the present invention.

FIG. 6 is a drawing that illustrates the apparatus used to perform the Fiorino test according to one embodiment of the present invention.

### DETAILED DESCRIPTION

The present invention relates to an ink composition that comprises a liquid vehicle, a colorant system, fluoropolymer particles and a specific polyurethane binder. In an embodiment, the ink composition is an inkjet composition. According to one embodiment, the present invention relates to a composition comprising an liquid vehicle, from about 0.1 to about 10 weight percent of a colorant system, from about 0.01 to about 5 weight percent of fluoropolymer particles and from about 0.01 to about 10 weight percent of polyurethane binders wherein the polyurethane binders have a percentage of hard segment which is below 49 percent. In other embodiment of the present invention, the ink composition may also include any other suitable additives.

It is believed that that it is with this specific combination that the composition has specific properties: excellent scratch resistance while maintaining good jettability. By scratch resistance, it is meant herein that the composition is resistant to all modes of scratching which include, scuff, abrasion and burnishing. By the term “scuff”, it is meant herein all damages to a print due to dragging something blunt across it (like brushing fingertips along printed image). Scuffs do not usually remove colorant but they do tend to change the gloss of the area that was scuffed. By the term “abrasion”, it is meant herein the damage to a print due to wearing, grinding or rubbing away due to friction. Abrasion is correlated with removal of colorant (i.e. with the OD loss). An extreme abrasive failure would remove so much colorant that the underlying white of the paper would be revealed. The term “burnishing” refers herein to changing the gloss via rubbing. A burnishing failure appears as an area of differential gloss in a print.

The ink compositions disclosed herein are also capable of enhanced decap performance. The term “decap”, as referred herein, means the ability of the inkjet ink to readily eject from the print head, upon prolonged exposure to air. It is to be understood that all of the materials of the ink composition are present in effective amounts so that the combination achieves the above characteristics when printed. Without being bound to any theory, it is believed that the fact that ink composition have excellent scratch resistance while maintaining good jettability, are due, at least in part, to the combination of fluoropolymer particles and specific polyurethane binders. When the ink according to embodiments of the present invention is used in inkjet photo printing, it results in photos that are more durable and last longer than inkjet photo printing currently on the market. Indeed, the resulting photos have good physical durability, enable scratch-free handling and resist to mechanical wear.

It is to be understood that the present system and method according to embodiments of the present invention are not limited to the particular process and materials disclosed herein as such and may vary to some degree. It is also to be understood that the terminology used herein is used for the purpose of describing particular embodiments only and is not intended to be limiting, as the scope of the present invention will be defined only by the appended claims and equivalents thereof.

In the present specification, and in the appended claims, the following terminology will be used: the singular forms “a,” “an,” and “the” include plural referents unless the context clearly dictates otherwise. The terms “about” and “approximately,” when referring to a numerical value or range is intended to encompass the values resulting from experimental error that can occur when taking measurements. Concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a weight range of approximately 1 wt % to approximately 20 wt % should be interpreted to include not only the explicitly recited concentration limits of 1 wt % to approximately 20 wt %, but also to include individual concentrations such as 2 wt %, 3 wt %, 4 wt %, and sub-ranges such as 5 wt % to 15 wt %, 10 wt % to 20 wt %, etc. Unless indicated otherwise, the percentage (%) of components present in the ink composition according to embodiment of the present invention expresses the weight percentage (wt %) of components, i.e. the percentage by weight of the total composition.

Polyurethane Binders

The ink composition comprises polyurethane binders. Polyurethane binders have a percentage of hard segments which represent at most 49% of the entire binder structure. In an embodiment, such percentage of hard segment is below 45% and in another embodiment below 40%. By percentage of hard segment, it is meant herein the percentage of hard segment versus soft segment presents in the entire polymer. Indeed, it is with this specific parameter that the ink compositions show excellent printability characteristics, i.e. have good decap time. Furthermore, it is within this specific percentage of hard segment that the polyurethane binders have the desired properties and generate ink compositions that are able to provide prints which exhibit resistance to a variety of durability failure modes, especially abrasion, scuff and burnishing. It is believed that the properties of polyurethane binders are based on the ratio of the hard and soft copolymer segments of the polymer.

Polyurethane binders are linear segmented copolymers joined by urethane links. Polyurethane binders are formed through step-growth polymerization, mainly by reacting a monomer containing at least two isocyanate functional groups with another monomer containing at least two alcohol groups in the presence of a catalyst. Polyurethanes binders are made of hard segments and soft segments. As used herein the “soft segment” of polyurethane binders encompasses the relatively flexible component derived from a macrodiol. In an embodiment, soft segments are formed from high molecular weight polyols. In another embodiment, in polyurethane binders, the soft segment is a polyether or a polyester macrodiol. As used herein the “hard segment” of polyurethane polymers encompasses a relatively hard and stiff component derived from a diisocyanate and a chain extender. In an embodiment, hard segments are formed from isocyanate and chain extenders. The hard segments are covalently coupled to the soft segments. The urethane hard segment domains serve as cross-links between the amorphous polyether soft segment domains. In other term, it can be stated that the hard segment is the part of the polymer that has a crystalline structure as opposed to the amorphous, rubbery structure of the soft segment.

In an embodiment, the polyurethane binders are used in the salt form and, in another embodiment, as an aqueous dispersion. Example of possible salts are ammonium and potassium salt. In an embodiment, polyurethane binders are used under a potassium salt form. In another embodiment, the polyurethane binders have a weight-average molecular weight ranging from about 1,000 to about 200,000; in another embodiment, ranging from about 5,000 to about 100,000. In an embodiment, the acid number of the polyurethane binders is in the range of from about 10 to about 200, in another embodiment in the range of from about 20 to about 100, and in another embodiment in the range from about 40 to about 50. The acid number is expressed in milligrams of KOH required to neutralize one gram of the polymer.

In an embodiment of the present invention, polyurethane binders are present in an effective amount ranging of from about 0.01% to about 10% by weight, in another embodiment, in an amount of from about 0.1% to about 5% by weight, and in another embodiment, in an amount of from about 0.1% to about 4% by weight of the ink composition.

Another characteristic of polyurethane binders is that such binders have a low glass transition temperature (Tg). By low glass transition temperature, it is meant herein temperature below 50° C., in an embodiment, in the range of from about 5° C. to about 50° C. Thus, in an embodiment, the polyurethane has a glass transition temperature, in a range from approximately 5° C. to approximately 50° C., in another embodiment with Tg at approximately 27° C. as measured by dynamic scanning calorimetry (DSC) and with a heating rate of 20° C./minute. It is important to remark that the glass transition temperature (Tg) is correlated with the percentage of hard segments present in the polyurethane binders, i.e. the less percentage of hard segments is present, the lower the glass transition temperature is.

In an embodiment, the polyurethane binders include a polyether polyol, an aliphatic isocyante and an acid group. In another embodiment, the polyether polyol is a difunctional polyether polyol such as polyethylene glycol (PEG), polypropylene glycol (PPG) and polytetramethylene glycol (PTMG). PTMG-1000 and PTMG-2000; in an embodiment polyether polyols are used. The aliphatic-isocyanate can be hexamethylene isophorone diisocyanate (IPDI), diisocyanate-1,6 (HDI), 4,4-dicyclohexylmethane-diisocyanate (H12-MDI), cyclohexane diisocyanate (CHDI), tetramethylxylene diisocyanate (TMXDI), and 1,3-bis(isocyanatomethyl)cyclohexane (H6XDI). In an embodiment, the aliphatic-isocyanate is IPDI. In another embodiment, the acid group is dimethylolpropionic acid (DMPA). The polyurethane also does not include chain extenders (e.g. difunctional compounds such as hydroxylamines, glycols or diamines that are often used to influence the end properties of polyurethanes). In another embodiment of the present invention, the polyurethane binders include polytetramethylene glycol (PTMG) as the polyether polyol, isophorone diisocyanate (IPDI) as aliphatic isocyante and dimethylolpropionic acid (DMPA) as acid group. In another embodiment, the polyurethane binders have less than about 40% of hard segment, a molecular weight of from 40 000 to 50 000 and an acid number of from 40 to 45. In another embodiment, the polyurethane binders include polyether polyol, aliphatic isocyanate and an acid group and not include chain extenders.

In an embodiment of the present invention, the percentage of polyether polyol, present in the polyurethane polymers, is comprised between 10% and 70%, in another embodiment between 55% and 65%. In an embodiment of the present invention, the percentage of aliphatic isocyanate, present in the polyurethane polymers, is comprised between 20% and 60%, in another embodiment between 25% and 35%. In an embodiment, the percentage of acid group, present in the polyurethane polymers, is comprised between 2% and 30%, in another embodiment between 5% and 15%.

Fluoropolymer Particles

The composition comprises fluoropolymer particles. Any suitable fluoropolymer particles are used; in an embodiment, such particles are emulsified, suspended, and otherwise dispersible in an aqueous medium. The fluoropolymer particles can have any suitable melting point. In an embodiment, the melting point is as high as 3500° C., in an embodiment between about 50° C. and 400° C., in another embodiment between 315° C. and 390° C. and in another embodiment, between 360° C. and 380° C.

In an embodiment of the present invention, the fluoropolymer particles are fluoropolymer dispersions, fluoroadditive resins, and/or fluoropolymer resins. In an embodiment, the fluoropolymer particles are fluoroethylene particles. In another embodiment, fluoropolymer particles are polytetrafluoroethylene (PTFE). In another embodiment, such polytetrafluoroethylene (PTFE) particles have a low molecular weight. One such low molecular weight PTFE is sold by DuPont Corporation, under the tradename Teflon®TE-3887N, which is a negatively charged hydrophobic colloid containing approximately 60% by total weight of 0.05 to 0.5 jim PTFE resin particles suspended in water. Teflon®TE-3887N also contains approximately 6% by weight of PTFE, a nonionic wetting agent and a stabilizer which is the ammonium salt of perfluoro octanoate. Teflon®TE-3887N has a peak melting point of about 370° C. and an average particles diameter of 0.2 pm. Other examples of particles which may be used in an embodiment of the present invention include Refined Karagami wax from Concord, Concord Premium Wax SE microemulsion, Diamond Shamrock Chlorowax: 40 liquid chlorinated paraffin, polyethylene waxes from Hoechst, for example, type PE-130, PE-190 and Ceridust 3620; beeswax (NF grade, M.P. 62′-65*C; Japan Wax NJ-2 (Natural wax, m.p. 480-540C.) from Astor Wax Corporation; Concord waxes, for example, Concord SE Premium wax (Self emulsified, m.p. 85.50C.), Refined Concord Wax #407 (M.P. 86.C.), #159 (m.p. 84′C.), #190 (M.P. 90′C.), #1600 (M.P. 84.50C.), Concord Cowax (M.P. 84′C.), and specialty waxes such as Concord microcrystalline wax #100 (M.P. 86′C.), Concord Wax WS-1027 (m.p. 61′C.), Concord Wax #5000 (M.P. 101.50C.) and Concord Beeswax Substitute (M.P. 79.5C.).

In an embodiment, fluoropolymer particles are present, in the composition, in an amount of from about 0.01% to about 5% by weight of the ink composition; in an embodiment, in an amount of from about 0.1% to about 1% by weight; in another embodiment, in an amount of from about 0.1% to about 0.5% by weight of the jet ink composition and, in another embodiment, in an amount of from about 0.25% to about 0.5% by weight of the ink composition. For example, in an embodiment, Teflon® TE-3887N suspension is used in an amount of from about 0.01% to about 5% by weight of the jet ink composition, in a embodiment, in an amount of from about 0.1% to about 1% by weight of the jet ink composition and, in another embodiment, from about 0.1% to about 0.5% by weight of the jet ink composition and, in another embodiment, in an amount of from about 0.25% to about 0.5% by weight of the ink composition.

While not intending to be bound to any particular theory, it is believed that the fluoropolymer particles lower the surface friction of the images. The fluoropolymer particles contribute to obtain compositions which provide images having excellent resistance burnishing and resistance to scuff, such as fingernail nicking. The rub resistance and the scratch resistance of the printed images are therefore increased.

Colorant

The ink composition comprises one or more colorants that impart the desired color to the printed message. As used herein, “colorant” includes dyes, pigments, and/or other particulates that may be suspended or dissolved in an ink vehicle. The colorant system is present in an amount of from about 0.1% to about 10% by weight, in an embodiment in an amount of from about 1% to about 6% by weight, and in another embodiment in an amount of from about 1% to about 4% by weight of the ink composition. The colorant is generally present in the ink composition in an amount required to produce the desired contrast and readability.

In an embodiment, according to the present invention, the inks comprise pigments as colorants. Pigments that can be used include self-dispersed pigments and non self-dispersed pigments. Self-dispersed pigments include those that have been chemically surface modified with a charge, a small molecule attachment or a polymeric grouping. This chemical modification aids the pigment in becoming and/or substantially remaining dispersed in a liquid vehicle. In another embodiment, pigment is a non self-dispersed pigment that utilizes a separate and unattached dispersing agent (which can be a polymer, an oligomer, or a surfactant, for example) in the liquid vehicle or physically coated on the surface of the pigment. The dispersing agent can be non-ionic or ionic, anionic or cationic. In an embodiment, colorants are polymer-dispersed pigments; in another embodiment, colorants are an acrylic resin-dispersed pigment.

The pigments suitable for use may have any suitable particle size. In an embodiment, the pigments of the present composition have particle size of from about 10 nm to about 1000 nm, in another embodiment of from 10 nm to about 500 nm in diameter and in another embodiment of from 50 nm to 150 nm.

In an embodiment, suitable pigments are black pigments, white pigments, cyan pigments, magenta pigments, yellow pigments, or the like. Pigments, according to an embodiment of the present invention, are organic or inorganic particles as well known in the art.

Suitable inorganic pigments include, for example, carbon black. However, other inorganic pigments may be suitable such as titanium oxide, cobalt blue (CoO-AI2O3), chrome yellow (PbCrO4), and iron oxide. Suitable organic pigments include, for example, azo pigments including diazo pigments and monoazo pigments, polycyclic pigments (e.g., phthalocyanine pigments), insoluble dye chelates, nitropigments, nitroso pigments, and the like. Representative examples of phthalocyanine blues include copper phthalocyanine blue and derivatives thereof (Pigment Blue 15). Representative examples of quinacridones include Pigment Orange 48, Pigment Orange 49, Pigment Red 122, Pigment Red 192, Pigment Red 202, Pigment Red 206, Pigment Red 207, Pigment Red 209, Pigment Violet 19 and Pigment Violet 42. Representative examples of anthraquinones include Pigment Red 43, Pigment Red 194, Pigment Red 216 and Pigment Red 226. Representative examples of perylenes include Pigment Red 123, Pigment Red 149 (Scarlet), Pigment Red 179, Pigment Red 190, Pigment Violet 19, Pigment Red 189 and Pigment Red 224. Representative examples of heterocyclic yellows include Pigment Yellow 1, Pigment Yellow 3, Pigment Yellow 12, Pigment Yellow 13, Pigment Yellow 14, Pigment Yellow 17, Pigment Yellow 65, Pigment Yellow 73, Pigment Yellow 74, Pigment Yellow 151, Pigment Yellow 117, Pigment Yellow 128, Pigment Yellow 155, Pigment Yellow 83, Pigment Yellow 213, and Pigment Yellow 138. Such pigments are commercially available in either powder or press cake form from a number of sources including, BASF Corporation, Engelhard Corporation and Sun Chemical Corporation. In an embodiment, examples of black pigments that are used include carbon pigments. The carbon pigment is any commercially available carbon pigment that provides acceptable optical density and print characteristics. Carbon pigments suitable for use in embodiments of the present invention include, without limitation, carbon black, graphite, vitreous carbon, charcoal, and combinations thereof. Such carbon pigments can be manufactured by a variety of known methods such as a channel method, a contact method, a furnace method, an acetylene method, or a thermal method, and are commercially available from such vendors as Cabot Corporation, Columbian Chemicals Company, Degussa AG, and E.I. DuPont de Nemours and Company. Suitable carbon black pigments include, without limitation, Cabot pigments such as Monarch 1400, Monarch 1100, CAB-O-JET 200, Black Pearls, and Vulcan pigments; Columbian pigments such as Raven 7000 and Raven 3500; Degussa pigments such as Color Black FW 200, Raven FW S170, Special Black 6, Special Black 5, Special Black 4, and Printex 140V; and Tipure R-available from Dupont and the like. Examples of other suitable colored pigments are described in the Colour Index, 3rd edition (The Society of Dyers and Colourists, 1982). The above list of pigments includes unmodified pigment particulates, small molecule attached pigment particulates, and polymer-dispersed pigment particulates. Other pigments not specifically listed can also be suitable for use within embodiments of the present invention. The above-illustrated pigments can be used singly or in combination of two or more, or in combination with anionic or nonionic dyes.

In an embodiment, according to the present invention, the inks comprise dyes as colorants. Examples of dyes suitable for use in the preparation of the ink composition include, but are not limited to, the yellow dyes such as C.I. Solvent Yellow 19 (C.I. 13900A), C.I. Solvent Yellow 21 (C.I. 18690), C.I. Solvent Yellow 61, C.I. Solvent Yellow 80, FD&C Yellow #5, and the like, the orange dyes such as C.I. Solvent Orange 1 (C.I. 11920), C.I. Orange 37, and the like, red dyes such as C.I. Solvent Red 8, C.I. Solvent Red 81, C.I. Solvent Red 82, and the like, pink dyes such as Diaresin Pink M (Mitsubishi Chemical Industries, Ltd.), and the like, violet dyes such as C.I. Solvent Violet 8, and the like, blue dyes such as C.I. Solvent Blue 2, C.I. Solvent Blue 11, and the like, black dyes such as C.I. Solvent Black 3, Acid Black 123, and the like. Some of the pigments and dyes are commercially available in convenient dispersions and may be used in the preparation of the ink composition according to embodiments of the present invention. For instance, carbon black is available from Penn Color Inc., Doylestown, Pa., as ACROVERSE™ Dispersion No. 91B188C. Rhodamine (Blue Shade) is available as a dispersion containing 40% Rhodamine, and phthalocyanine green is available as a dispersion containing 60% phthalocyanine green. All percentages are by weight of the dispersion.

Liquid Vehicle

As used herein, “liquid vehicle” is defined to include any liquid composition that is used to carry colorants, including pigments, to a substrate. Liquid vehicles are well known in the art, and a wide variety of liquid vehicle components may be used in accordance with embodiments of the present invention. Such liquid vehicles may include a mixture of a variety of different agents, including without limitation, surfactants, solvent and co-solvents, buffers, biocides, viscosity modifiers, sequestering agents, stabilizing agents, and water. Though not liquid per se, the liquid vehicle can also carry other solids, such as polymers, UV curable materials, plasticizers, salts, etc. In an embodiment, the composition includes liquid vehicle which comprises an organic solvent, surfactants and water. In another embodiment, liquid vehicles are inkjet liquid vehicles.

Organic Solvent

In an embodiment, organic solvent is part of the liquid vehicles. Organic solvents are typically used to increase the solubility or the dispersibility of the resin or of the colorant that might be present in the composition. Any suitable organic solvent can be used. Examples of suitable classes of organic solvents include the polar solvents such as amides, esters, ketones, lactones and ethers. Examples of suitable organic solvents thus include N-methylpyrrolidone (NMP), dimethyl sulfoxide, sulfolane, and glycol ethers. In an embodiment, the solvent is Dantocol DHE. Examples of glycol ethers include the mono- and di-alkyl ethers of alkylene glycols in which the alkyl group contains 1-6 carbon atoms (e.g., methyl, ethyl, propyl, butyl, etc.) and the alkylene glycol has 2-6 carbon atoms. Examples of suitable monoalkyl alkylene glycol ethers include ethylene glycol methyl ether, ethylene glycol ethyl ether, ethylene glycol butyl ether, ethylene glycol hexyl ether, diethylene glycol methyl ether, diethylene glycol ethyl ether, diethylene glycol butyl ether, propylene glycol methyl ether, dipropylene glycol methyl ether, tripropylene glycol methyl ether, triethylene glycol ethyl ether, triethylene glycol methyl ether, and the like.

In an embodiment, the ink composition includes as solvent a component selected from the group consisting of 2,4-imidazolidinedione-1,3-bis(2-hydroxyethyl)-5,5-dimethyl, betaine and combinations thereof. In another embodiment, the solvent is 4-imidazolidinedione-1,3-bis(2-hydroxyethyl)-5,5-dimethyl. The organic solvent is typically used in an amount of from about 0.1% by weight to about 30% by weight of the ink composition and, in another embodiment, in an amount of from about 8% weight to about 25% by weight of the ink composition.

Surfactants

In an embodiment, surfactants are part of the liquid vehicles. In an embodiment, the ink composition includes one or more surfactants. Surfactants are added, mainly, to adjust the surface tension of the ink to an appropriate level. The surfactants may be anionic, nonionic, amphoteric surfactants or mixture thereof.

Examples of suitable nonionic surfactants include, linear or secondary alcohol ethoxylates (such as the Tergitol® series available from Union Carbide and the Brij® series from Uniquema), ethoxylated alkyl phenols (such as the Triton® series from Union Carbide), fluoro surfactants (such as the Zonyls® from DuPont; and the Fluorads® from 3M), fatty acid ethoxylates, fatty amide ethoxylates, ethoxylated and propoxylated block copolymers (such as the Pluronic® and Tetronic® series from BASF, ethoxylated and propoxylated silicone based surfactants (such as the Silwet® series from CK Witco), alkyl polyglycosides (such as the Glucopons® from Cognis) and acetylenic polyethylene oxide surfactants (such as the Surfynol® from Air Products). Examples of anionic surfactants include carboxylated (such as ether carboxylates and sulfosuccinates), sulfated (such as sodium dodecyl sulfate), sulfonated (such as dodecyl benzene sulfonate, alpha olefin sulfonates, alkyl diphenyl oxide disulfonates, and alkyl naphthalene sulfonates), phosphated (such as phosphated esters of alkyl and aryl alcohols, including the Strodex® series from Dexter Chemical), phosphonated and amine oxide surfactants and anionic fluorinated surfactants. Examples of amphoteric surfactants include betaines, sultaines, and aminopropionates. Examples of cationic surfactants include quaternary ammonium compounds, cationic amine oxides, ethoxylated fatty amines and imidazoline surfactants. Additional examples of the above surfactants are described in “McCutcheon's Emulsifiers and Detergents: 1995, North American Editor”. Surfactants are used in an amount of from about 0.01 to 5% by total weight of the ink composition; in an embodiment, in an amount of from about 0.1% to about 4% by weight and in another embodiment in an amount of from about 0.5% to about 4% by total weight of the ink composition.

Water

In an embodiment, the ink composition includes water. In an embodiment, water is used as the ink carrier for the composition and is part of the liquid vehicle. Generally, the water makes up the balance of the ink composition, and is typically present in an amount of from about 40% weight to about 80% by weight, in an embodiment of from about 50% by weight to about 80% by weight of the composition. In order to prevent the clogging of ink jet tip by dissolved salts in the water, deionized water may be used in the preparation of the ink composition.

In addition to water, various types of additives may be employed in the ink composition to optimize the properties of the ink composition for specific applications. For example, the ink composition may also include any number of buffering agents and/or biocides. Any number of commonly known buffers may be used to establish a desired pH level in the ink system. Additionally, in an embodiment of the present invention, various biocides are used to inhibit growth of undesirable microorganisms. Several examples of suitable biocides include, but are in no way limited to, benzoate salts, sorbate salts, commercial products such as Nuosept® (ISP), Ucarcide® (Dow), Vancide® (RT Vanderbilt Co.), and Proxel® (Avecia), Kordek® MLX (Rohm and Haas) and other known biocides. Typically, such biocides are comprised in amount representing less than about 5 wt % of the ink composition and often from about 0.05 wt % to about 2 wt %. Sequestering agents such as EDTA may be included to substantially eliminate potential deleterious effects of heavy metal impurities (if any).

The pH of the ink composition may be varied as desired. In an embodiment, the pH of the ink ranges from about 4 to about 10, depending upon the type of colorant being used. In another embodiment, the pH of the present ink is from 5 to 9 and, in another embodiment, from 5.5 to 7.5. The pH of the ink compositions may be adjusted by the addition of organic or inorganic acids or bases, i.e. pH adjusting agent. Typical pH adjusting agent includes inorganic acids such as hydrochloric, phosphoric and sulfuric acids. Typical organic acids include methane sulfonic, acetic and lactic acids. Typical inorganic bases include alkali metal hydroxides and carbonates. In an embodiment, pH adjusting agent is ammonium hydroxide. Any suitable amount of the pH adjusting agent can be used. Generally, the pH adjusting agent is used in an amount of from about 0.1% by weight to about 1% by weight, and, in an embodiment, in an amount of from about 0.3% by weight to about 0.7% by weight of the composition.

In an embodiment, the ink compositions have a viscosity within the range of about 1.0 to about 10 cps, and, in another embodiment, of about 1.0 to about 7.0 cps, as measured at 25° C., in order to achieve the desired rheological characteristics. As indicated above, the viscosity of the ink composition is conveniently regulated, as known to those of ordinary skill in the art, for instance, by suitable choice of the quantity and the molecular weight of the binders resin, the organic solvent, the wax, and other additives.

In an embodiment, the present invention provides a method of forming printed images on surfaces using the ink composition in a heated environment. The method comprises projecting a stream of droplets of the ink composition onto a surface to form the desired printed image. The inkjet ink composition may be established on the substrate via any suitable inkjet printing technique. Non-limitative examples of such inkjet printing techniques include thermal, acoustic, and piezoelectric inkjet printing. In an embodiment, the inks are utilized in thermal printer. The images are printed on porous and non-porous surfaces, in an embodiment on porous surfaces, using the ink composition of embodiments of the present invention. In another embodiment, the substrate is paper (non-limitative examples of which include plain copy paper or papers having recycled fibers therein) or photo-paper (non-limitative examples of which include polyethylene or polypropylene extruded on one or both sides of paper), and/or combinations thereof. In an embodiment, the substrate has a thickness along substantially the entire length ranging between about 0.025 mm and about 0.5 mm. As used herein, “images” refers to marks, signs, symbols, figures, indications, and/or appearances deposited upon a substrate with either visible or an invisible ink composition. Examples of an image can include characters, words, numbers, alpha-numeric symbols, punctuation, text, lines, underlines, highlights, and the like.

In an embodiment, a fixer fluid may be established on the substrate prior to the establishment of the ink composition. Without being bound to any theory, it is believed that the fixer fluid advantageously aids in achieving good print quality by holding colorants and binders on the substrate surface. Suitable fixer fluid ingredients include, but are not limited to acids (non-limitative examples of which include organic acids), salts (non-limitative examples of which include bi- or tri-valent metal salts), cationic polymers (non-limitative examples of which include polymers with quaternary ammonium salts), and/or combinations thereof.

In another embodiment, the inks are utilized in an ink jet set comprising, at least, magenta, cyan, yellow and black inks Colorless ink compositions that contain non-colored particles and no colorant may also be used.

In an embodiment, the present invention also relates to a method of making an ink composition. The method comprises the steps of combining from about 0.01 wt. % to about 10 wt. % of a polyurethane binders, having a percentage of hard segment which is below 49 percent, with from about 0.1 wt. % to about 10 wt. % of a colorant system and with an liquid vehicle; then mixing from about 0.01 wt. % to about 5 wt. % of fluoropolymer particles with such combination in view of producing the ink composition according to embodiments of the present invention. The resulting composition will have excellent scratch resistance and good jettability.

To further illustrate embodiment(s) of the invention, various examples are given herein. It is to be understood that these are provided for illustrative purposes and are not to be construed as limiting the scope of the disclosed embodiment(s).

### Example 1

### Ink Formulation

A number of ink formulations, in accordance with embodiments of the present invention, were prepared using the components and ranges shown in Table 1. Formula is expressed in weight percentage of each component in the ink composition.

TABLE 1

| Component | Ink 1 | Ink 2 | Ink 3 | Ink 4 | Ink 5 | Ink 6 | Ink 7 | Ink 8 |
|---|---|---|---|---|---|---|---|---|
| Organic solvent¹ | 12.5 | 12.5 | 12.5 | 12.5 | 12.5 | 12.5 | 12.5 | 12.5 |
| Biocide² | 0.25 | 0.25 | 0.25 | 0.25 | 0.25 | 0.25 | 0.25 | 0.25 |
| pH balancer³ | 1.5 | 1.5 | 1.5 | 1.5 | 1.5 | 1.5 | 1.5 | 1.5 |
| Surfactant⁴ | 0.5 | 0.5 | 0.5 | 0.5 | 0.5 | 0.5 | 0.5 | 0.5 |
| Pigment⁵ | 3 | 3 | 3 | 3 | 3 | 3 | 3 | 3 |
| fluoropolymer | — | 0.25 | 0.25 | 0.25 | 0.25 | 0.25 | 0.25 | 0.25 |
| particles⁶ | | | | | | | | |
| PU E | 1 | 1 | — | — | — | — | — | — |
| PU C | — | — | 1 | — | — | — | — | — |
| PU D | — | — | — | 1 | — | — | — | — |
| PU A | — | — | — | — | 1 | — | — | — |
| PU B | — | — | — | — | — | 1 | — | — |
| PU F | — | — | — | — | — | — | 1 | — |
| PU G | — | — | — | — | — | — | — | 1 |
| Water | balance | balance | balance | balance | balance | balance | balance | balance |

¹Organic solvent Dantocol DHE available from Lonza Inc.
²Biocide is Kordek ® MLX available from Rohm and Haas
³pH balancer is triethanolamine.
⁴Surfactant is surfynol ® available from Air Products
⁵Pigment is polymer dispersed pigment, Magenta E02 available from Clariant.
⁶Fluoropolymer particles are Teflon ®TE-3887N

Table 2 defines the polyurethane binders used in inks of table 1 according to embodiments of the present invention. Polyurethane binders are defined according to their percentage of hard segment: (1) Polyurethane binders with high degree of hard segment (i.e. above 49%) which have a relatively high Tg and (2) Polyurethane binders with low degree of hard segment (i.e. below 49%) which have a relatively low Tg. The polyurethane polymers comprise PTMG as polyether polyol, IPDI as aliphatic isocyante and DMPA as acid group.

PU E is Poly[hydro-hydroxy-Poly(oxy-1,4-butanediyl)]-[hydroxy-2-(hydroxymethyl)-2-methyl-propanoic acid]-[5-isocyanato-1-(isocyanatomethyl)-1,3,3-trimethyl-cyclohexane] (See Reference: J. Kahovec, R. B. Fox, and K. Hatada, Pure Appl. Chem., 2002, Vol. 74, No. 10, pp. 1921-1956).

TABLE 2

| Polyurethane binders | % of hard segment | Relative Tg |
|---|---|---|
| PU A | 61 | High |
| PU B | 62 | High |
| PU C | 50 | High |
| PU D | 65 | Very High |
| PU E | 39 | Low |
| PU F | 45 | Low |
| PU G | 34 | Low |

The above mentioned ink compositions, according to embodiments of the present invention, are printed on photo-papers. As illustrated below, compositions that are generated according to the embodiments of the present invention (Inks 2, 7 and 8) exhibit excellent scratch resistance and physical durability, such as scuff, abrasion and burnishing resistances. Furthermore, inks 2, 7 and 8 also provide good jettability, high optical density and printing qualities when printed with a heated printing system.

### Example 2

### Abrasion Test

An oscillating sand abrasion test (OSAT) is used to quantitatively compare scratch resistance in different ink formulations. The test is performed as follows: an optical density test plot is prepared having printed samples on the plot representing a 16 level density ramp of increasing printed ink optical densities. The optical density and the gloss of each sample on the plot are measured before being submitted to OSAT. The plot is placed in a tray under a layer of sand. The tray is shaken for a given amount of time (3 minutes) at a given rate (250 strokes per minute). The optical density and the gloss of each sample on the plot are measured again, after each sample is scratched by the sand. The optical density loss percentage and the gloss are computed. The steps are repeated for different ink test plots. Percent optical density loss and gloss are compared for the range of inks tested. The optical density of the print is measured with a Gretag Macbeth SpectroScan instrument. D50 (“daylight”) illumination is used at an observer angle of 2°. The density standard is ANSI A. The gloss and haze of the print are measured with a BYK Gardner MicroHaze Plus instrument. The gloss and haze measurements are made with incident light at a 20° angle.

At different density levels on the ramp, different mechanisms of durability failure come into play. Up until about density level 10, the ink film is not yet fully contiguous on the media. At the density level above level 10, the ink forms a continuous film and the film is more abrasion-resistant. Generally, an optical density loss above level 10 is due to the quick loss of gloss and the failure of ink film cohesion. In contrast, below density level 10, dot adhesion to the page is a significant durability factor. It can be said that the most sensitive area of the graph in terms of density loss is between density level 4 and 10. In this range, the printing surface is nearly fully covered with dots. However, the film is not yet contiguous and discreet dots, or dot edges, are still present. For this reason, in the range of density level 4 to 10, dot adhesion to the paper surface and dot adhesion failure become more significant factors relative to other factors. It can be said, however, that from levels 4 to 10, gloss loss and cohesive failure can be influential factors as well. At density levels of 3 and below, both adhesive and cohesive failure are still significant, but there are fewer dots on the paper so the initial density is very low. Therefore, at density levels of 3 and below, measurement error can be present. In light of these facts about the density ramp, it is advisable to pay particular attention to the density loss between density levels 4 and 10. However, to obtain an overall picture of durability, the testing of all 16 durability levels is desirable.

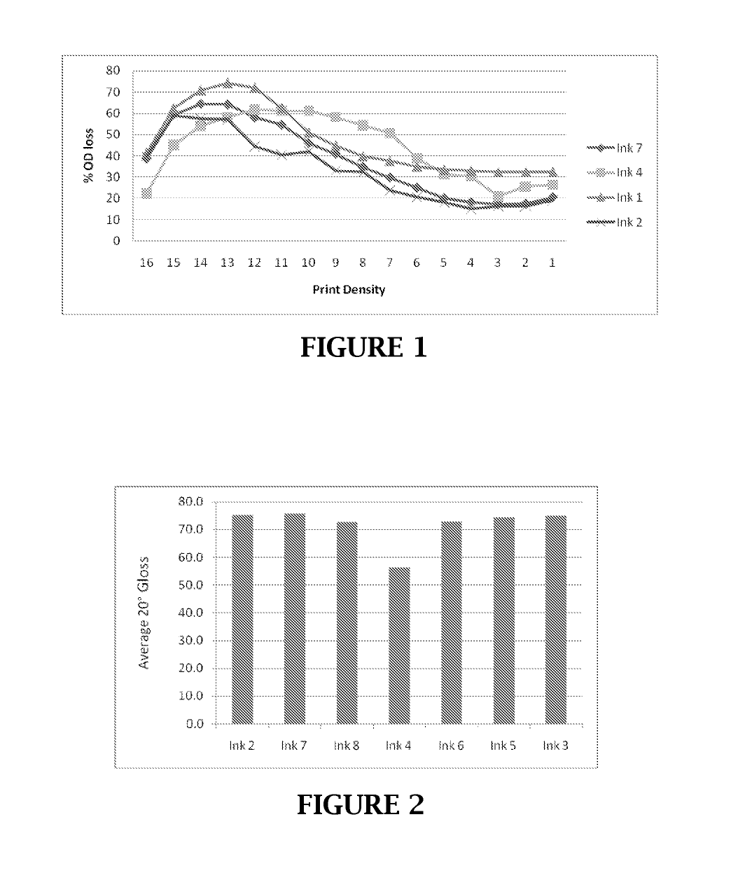

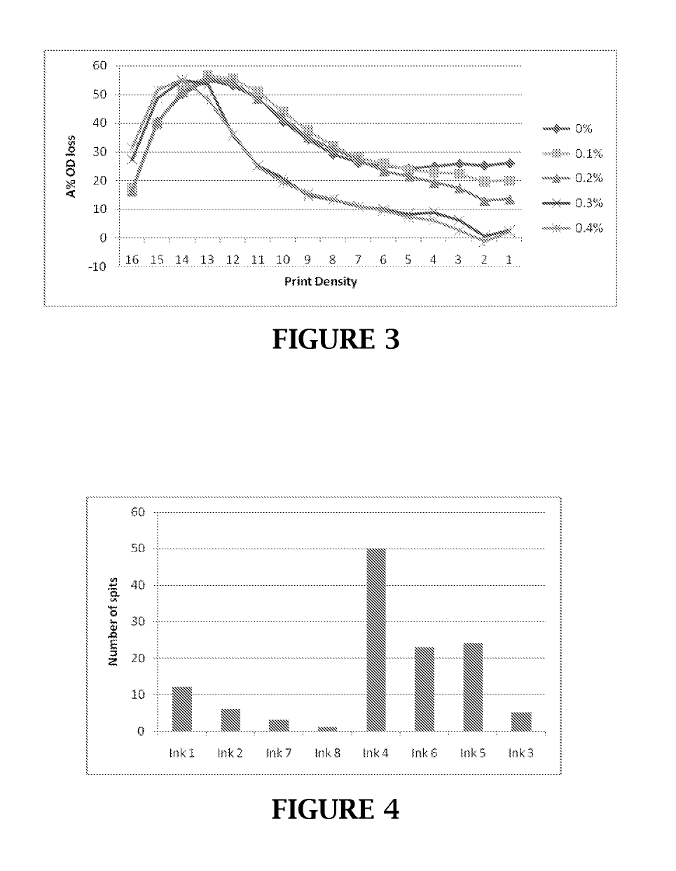

The OSAT test is performed to determine scratch resistance of different ink compositions, according to embodiments of the present invention, with different polyurethane binders (inks 1 to 8). The results are shown in FIGS. 1, 2 and 3. FIG. 1 represents a graph showing OD loss (in %) vs. Print Density for inks containing polyurethane binders having low percentage of hard segment (inks 2 & 7) as compared to the ink with polyurethane binders having high percentage of hard segment (ink 4) and not containing fluoropolymer particles (ink 1). FIG. 1 demonstrates that there is less optical density loss for ink containing fluoropolymer particles and polyurethane binders having low percentage of hard segment (Inks 2 & 7). FIG. 2 represents series of bar graphs represented which compare gloss, for different inks containing polyurethane binders having low or high percentage of hard segment according to embodiments of the present invention. The bar graphs of FIG. 2 show a better gloss for the ink containing polyurethane binders having low percentage of hard segment (inks 2, 7 & 8) as compared to the ink with polyurethane binders having high percentage of hard segment (inks 3, 4, 5 & 6). FIG. 3 represents a graph showing OD loss (in %) vs. Print Density, for ink 1 with polyurethane with low percentage of hard segment (PU E), containing different level of fluoropolymer particles (Teflon® TE-3887N), from 0 to 0.4%. FIG. 3 clearly demonstrates that the presence of fluoropolymer particles improves optical density loss.

As a lower optical density loss percentage is equated to a greater scratch resistance, it is clear that polyurethane binders with low percentage of hard segment improve the scratch resistance of ink composition. Furthermore, it is demonstrated that the combination of polyurethane binders with fluoropolymer particles has an enhanced effect on the scratch resistance.

### Example 3

### Decap Test

The quality of a given ink being able to recover normal printing characteristics after sitting idle in an inkjet nozzle for a given period of time is referred to as “decap”. The ink decap time is measured as the amount of time that an ink printhead may be left uncapped before the printer nozzles no longer fire properly, potentially because of clogging or plugging.

Generally, the nozzle(s) may become clogged/plugged by a viscous plug that forms in the nozzle(s) as a result of water loss, crusting of the ink, and/or crystallization of the dye in and/or around any of the nozzles. If a nozzle has plugged, ink droplets ejected through the nozzle's orifice may be misdirected, which may adversely affect print quality. The orifice may also become completely blocked, and as a result, the ink droplets may not pass through the affected nozzle. Ink decap times are typically measured over short and long time periods. The short-time decap generally determines how long the printhead can be uncapped before drop quality degrades below the quality obtained with a freshly uncapped print head. Various print/image defects may result from this drop quality degradation due to decap. To counteract decap effects, the printer service routine requires the idle nozzles to spit on a regular basis into the waste container (spittoon) to avoid printing defects. In order to achieve good print image quality, while maintaining or improving throughput and saving ink, it is desirable to keep the short-time decap as long as possible, and to use as few spits as possible to refresh the nozzles. On the other hand, long-time decap determines how long a printhead can be stored in an uncapped state, before nozzles are no longer readily recoverable by the printer's servicing routines. In particular, it determines attributes of the printhead, such as, for example, the storage stability. Long-time decap is desirable for inks so that nozzles are able to be left uncapped and unused for extended periods of time, while the printheads can still be revived by servicing.

Decap testing was performed for several ink samples by allowing the printhead nozzles containing each given sample to idle for a given time and then determining how many spits of the nozzles were necessary to recover normal printing characteristics. The more spits it took to recover, the worse the printhead performance is for a given ink at a given time. In general, decap values below 4 spits are considered good, up to 10 spits are acceptable, and above 10 spits are considered unacceptable. The Decap test is performed to determine printing characteristics for inks 1 to 8. The results, illustrated in FIG. 4, determine the number of spits it takes for a pen to recover after idling for 3.5 s (A lower number means the ink is more printable). According to the results, it is clear that compositions containing fluoropolymer particles and polyurethane with low percentage of hard segment (inks 2, 7 and 8), exhibit good decap performances and thus exhibit greater printing characteristics.

### Example 4

### Fiorino Test

Fiorino scratch test simulates scratches due to burnishing and fingernail nicking. The

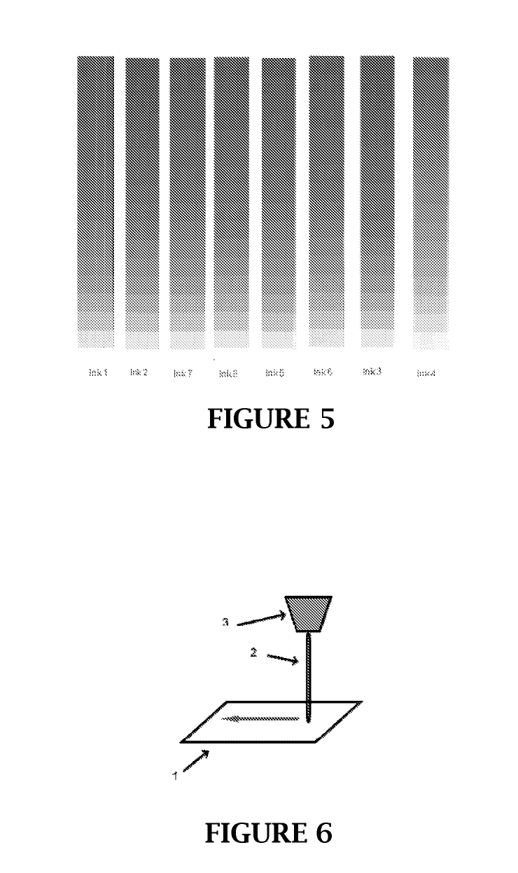

Fiorino test is performed for several ink samples with the apparatus illustrated in FIG. 6. Inks to be tested are used to print tapes on paper. A stylus (2) is dragged across the print (1). The stylus is weighted with different amounts of weight (3): 1000 g, 1500 g and 2000 g. The damages are assessed visually to the print as a function of stylus weight and print density. The test is repeated for different inks with or without fluoropolymer particles (0.1% Teflon® TE-3887N). The results are illustrated in FIG. 5: The first print tape on the left (ink 1) exhibits scratches while the other print tapes (inks 2, 7, 8, 5, 6, 3, 4) do not contain any. FIG. 5 demonstrates thus a greater resistance of inks containing fluoropolymer particles to burnishing and fingernail nicking by comparison to inks without fluoropolymer particles.

The preceding description has been presented only to illustrate and describe exemplary embodiments of the present invention. It is not intended to be exhaustive or to limit the system and method to any precise form disclosed. Many modifications and variations are possible in light of the above teaching. It is intended that the scope of the invention be defined by the following claims.

1. An ink composition comprising:
a. an liquid vehicle,
b. from about 0.1 to about 10 weight percent of a colorant system,
c. from about 0.01 to about 5 weight percent of fluoropolymer particles,
d. from about 0.01 to about 10 weight percent of polyurethane binders, wherein the polyurethane binders have a percentage of hard segment which is below 49 percent.

2. The composition of claim 1 wherein polyurethane binders are present in an amount representing from about 0.1% to about 5% by weight of the total composition.

3. The composition of claim 1 wherein polyurethane binders have a weight-average molecular weight ranging from about 1,000 to about 200,000.

4. The composition of claim 1 wherein polyurethane binders include polyether polyol, aliphatic isocyante and acid groups.

5. The composition of claim 4 wherein polyurethane binders include polytetramethylene glycol (PTMG) as polyether polyol, isophorone diisocyanate (IPDI) as aliphatic isocyante and dimethylolpropionic acid (DMPA) as acid group.

6. The composition of claim 1 wherein fluoropolymer particles are present in an amount representing from about 0.1% to about 1% by weight of the total composition.

7. The composition of claim 1 wherein fluoropolymer particles are fluoroethylene particles.

8. The composition of claim 1 wherein fluoropolymer particles are polytetrafluoroethylene (PTFE).

9. The composition of claim 1 wherein the colorant is a dispersed pigment having a particle size of from about 10 nm to about 1000 nm.

10. The composition of claim 1 wherein the colorant is an acrylic resin-dispersed pigment.

11. The composition of claim 1 wherein the liquid vehicle comprises: water, from about 0.1 to about 30 weight percent of an organic solvent and from about 0.01 to about 5 weight percent of surfactants by total weight of the ink composition.

12. A method of making an ink composition, comprising the steps of: combining from about 0.01 to about 10 wt. % of polyurethane binders having a percentage of hard segment which is below 49 percent with from about 0.1 to about 10 wt. % of a colorant system and with an liquid vehicle; and mixing from about 0.01 to about 5 wt. % of fluoropolymer particles with such combination; wherein the composition presents excellent scratch resistance and good jettability.

13. An ink set comprising at least one ink selected from the group consisting of black, cyan, magenta and yellow inks, wherein, at least, one ink comprises:
a. an liquid vehicle,
b. from about 0.1 to about 10 weight percent of a colorant system,
c. from about 0.01 to about 5 weight percent of fluoropolymer particles,
d. from about 0.01 to about 10 weight percent of polyurethane binders, wherein the polyurethane binders have a percentage of hard segment which is below 49 percent.
